(19) United States
(12) Patent Application Publication
(10) Pub. No.: US 2006/0051670 A1
(43) Pub. Date: Mar. 9, 2006

(54) Non-aqueous electrolyte secondary cell negative electrode material and metallic silicon power therefor

(75) Inventors: Mikio Aramata, Usui-gun (JP); Satoru Miyawaki, Usui-gun (JP); Hirofumi Fukuoka, Usui-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/213,744

(22) Filed: Aug. 30, 2005

(30) Foreign Application Priority Data
Sep. 3, 2004 (JP) 2004-257301

(51) Int. Cl. H01M 4/58; C01B 33/02; B32B 9/00

(52) U.S. Cl. 429/218.1; 252/182.1; 423/348; 428/404

(57) ABSTRACT

A metallic silicon powder is prepared by effecting chemical reduction on silica stone, metallurgical refinement, and metallurgical and/or chemical purification to reduce the content of impurities. The powder is best suited as a negative electrode material for non-aqueous electrolyte secondary cells, affording better cycle performance.

### CROSS-REFERENCE TO RELATED APPLICATION

This non-provisional application claims priority under 35 U.S.C. §119(a) on Patent Application No. 2004-257301 filed in Japan on Sep. 3, 2004, the entire contents of which are hereby incorporated by reference.

### TECHNICAL FIELD

This invention relates to a metallic silicon powder suitable for non-aqueous electrolyte secondary cell negative electrode material, typically as high-capacity negative electrode active material in lithium ion secondary cells, and a non-aqueous electrolyte secondary cell negative electrode material comprising the same.

### BACKGROUND ART

With the recent rapid progress of potable electronic equipment and communication equipment, secondary cells having a high energy density are strongly desired from the standpoints of economy and size and weight reduction. Prior art known attempts for increasing the capacity of such secondary cells include the use as the negative electrode material of oxides of V, Si, B, Zr, Sn or the like or compound oxides thereof (JP-A 5-174818, JP-A 6-60867 corresponding to U.S. Pat. No. 5,478,671), melt quenched metal oxides (JP-A 10-294112), silicon oxide (Japanese Patent No. 2,997,741 corresponding to U.S. Pat. No. 5,395,711), and Si₂N₂O or Ge₂N₂O (JP-A 11-102705 corresponding to U.S. Pat. No. 6,066,414). Also, for the purpose of imparting conductivity to the negative electrode material, it is known to prepare negative electrodes by mechanical alloying of SiO with graphite followed by carbonization (JP-A 2000-243396 corresponding to U.S. Pat. No. 6,638,662), coating of Si particle surfaces with a carbon layer by chemical vapor deposition (JP-A 2000-215887 corresponding to U.S. Pat. No. 6,383,686), coating of silicon oxide particle surfaces with a carbon layer by chemical vapor deposition (JP-A 2002-42806), and forming of a film from a polyimide binder followed by sintering (JP-A 2004-22433 corresponding to US 2003-0235762 A).

These prior art methods are successful in increasing the charge/discharge capacity and the energy density of secondary cells, but unsatisfactory in cycle performance. For a certain type of metallic silicon, undesired phenomena such as formation of an insulating layer on the electrode surface and contamination of the separator (electrolytic dissociation membrane) can occur upon repetition of charge/discharge cycles, which inhibit migration of lithium ions and electrons, detracting from cycle performance. There is a demand for a negative electrode active material featuring a low cost, better cycle performance, and a higher energy density.

In particular, JP-A 2000-215887 uses silicon as the negative electrode material, but lacks the specification of silicon itself. High-purity silicon powder used in Examples is very expensive and impractical. Metallic silicon of high purity which is available as the chemical reagent at a reasonable price is also impractical because it is poor or varies widely in cell characteristics such as cycle performance.

### SUMMARY OF THE INVENTION

An object of the invention is to provide a metallic silicon powder for non-aqueous electrolyte secondary cell negative electrode material and a non-aqueous electrolyte secondary cell negative electrode material, which are available at a reasonable cost and enable fabrication of a lithium ion secondary cell negative electrode having improved cycle performance.

The inventor has found that impurities in metallic silicon are present at grain boundaries, that when metallic silicon is ground and worked into a powder suited for negative electrode material, the impurities are exposed on particle surfaces, that when electrochemical cycles which are charge/discharge cycles in the case of batteries are repeated, the impurities undergo dissolution and precipitation, affecting cell performances such as cycle performance.

As previously described, the development of an electrode material having a high charge/discharge capacity is a great concern, and many engineers have been engaged in research. Under the circumstances, silicon, silicon oxides (SiOx) and silicon alloys, because of their high capacity, draw a great attention as the lithium ion secondary cell negative electrode active material. Studies have been made on the construction of negative electrode membrane therefrom. Of these, most silicon oxides have not reached the practical level because of their low initial efficiency. On the other hand, silicon is a very attractive material in that its capacity is greater than carbon-based materials by a factor of at least 10 and greater than silicon oxides by a factor of about 3. Thus the structure and construction of negative electrode membrane from silicon have been devised in various ways. Some effective approaches are carbon coating by thermal CVD and hybridization by SiC formation. However, even when the same treatment is carried out, silicon samples show varying degradation by repeated charge/discharge cycles, i.e., varying cycle performance. Research is being made using expensive silicon of the reagent grade. This, however, becomes a bottleneck against the development of practically acceptable lithium cells using silicon as the negative electrode active material. There is a need for inexpensive silicon of industrial grade having stable cell characteristics.

Making investigations to improve the cycle performance and initial efficiency of silicon, the inventor has discovered that they are largely dependent on the impurity zone (or impurity content) which is present as precipitates at grain boundaries in metallic silicon and that silicon having stable cycle performance is obtainable by managing or reducing the impurity content below a certain level.

The inventor has found the following. Once impurities are dissolved through electrochemical reaction, they migrate to the positive electrode and separator membrane and precipitate on the surface thereof to form an insulating film. The impurity zone is delaminated from the bulk during charge/discharge operation and the resulting microparticulates deposit on the separator membrane. These can degrade the cell performance. When metallic silicon is prepared by chemical reduction of silica stone, impurities can be introduced from the raw materials, silica stone and reducing agent and from process materials. If the amount of impurities present at grain boundaries or contained in crystal grains of silicon is controlled to below a certain level by purification, there is obtained a metallic silicon which when used as the lithium ion secondary cell negative electrode active material, undergoes minimal degradation by repeated charge/discharge, that is, has improved or stable cycle performance. Since the silicon in this state is not conductive, it is admixed with conductive carbon powder prior to use as the negative electrode active material. Alternatively, silicon particles are coated with carbon as by thermal CVD prior to use as the negative electrode active material. Equivalent effects are achievable by the admixing and the carbon coating.

In one aspect, the present invention provides a metallic silicon powder for non-aqueous electrolyte secondary cell negative electrode material, prepared by effecting chemical reduction on silica stone, metallurgical refinement, and metallurgical and/or chemical purification to reduce the content of impurities.

In a preferred embodiment, the content of impurities in the metallic silicon is reduced such that the contents of aluminum and iron present at grain boundaries are each up to 1,000 ppm, the contents of calcium and titanium are each up to 500 ppm, and the content of oxygen dissolved in silicon is up to 300 ppm.

In another preferred embodiment, the metallic silicon powder has an average particle size of up to 50 μm.

In a further preferred embodiment, silicon particles are surface treated with at least one surface treating agent selected from the group consisting of silane coupling agents, (partial) hydrolytic condensates thereof, silylating agents, and silicone resins.

In another aspect, the present invention provides a carbon-coated metallic silicon powder for non-aqueous electrolyte secondary cell negative electrode material, prepared by effecting thermal CVD on the metallic silicon powder of the one aspect for coating surfaces of metallic silicon particles with carbon.

In a further aspect, the present invention provides a non-aqueous electrolyte secondary cell negative electrode material comprising a mixture of the metallic silicon powder of the one aspect and a conductive agent, the mixture containing 5 to 60% by weight of the conductive agent and having a total carbon content of 20 to 90% by weight.

The metallic silicon powder which has been metallurgically prepared and purified according to the invention is useful as the negative electrode material for non-aqueous electrolyte secondary cells and exhibits improved cycle performance.

### BRIEF DESCRIPTION OF THE DRAWINGS

FIG. 1 illustrates SEM and Auger images in section of metallic silicon of chemical grade.

FIG. 2 is a photomicrograph under TEM illustrating a fused state at the interface between a silicon core and a carbon layer.

### DESCRIPTION OF THE PREFERRED EMBODIMENTS

As used herein, the term “conductive” refers to electrical conduction.

For use as the lithium ion secondary cell negative electrode active material, a siliceous material is expected promising because of its charge/discharge capacity which is several times greater than that of the current mainstream graphite-derived materials, but is prevented from practical use by the degradation of performance during repeated charge/discharge operation. The present invention relates to a siliceous negative electrode material having improved cycle performance and efficiency, and specifically, to a metallic silicon powder which is useful as non-aqueous electrolyte secondary cell negative electrode active material and whose impurity content is reduced by metallurgical and/or chemical purification, as indicated from the relationship to cell properties of impurities present in metallic silicon prepared by metallurgical refinement.

The metallic silicon of the invention is prepared by effecting chemical reduction on silica stone, metallurgical refinement, and metallurgical and/or chemical purification in sequence.

First, metallic silicon is prepared through chemical reduction of silica stone. It is generally divided into two types: alloy use to form aluminum alloys and chemical use for the synthesis of organohalosilanes as sources toward silicones or for the preparation of trichlorosilanes as sources toward semiconductor silicon. For the alloy use, no problems except purity are found with the metallic silicon as chemically reduced. For the chemical use, complex problems arise from combination of reactivity, activity, selectivity and the like, requiring a severe management of the amounts of impurities and a balance thereof. Since these impurities mostly originate from the raw material, naturally occurring silica stone, it is in fact impossible to reduce the amount of impurities to below a certain level without a purification step. As is well known in the art, readily oxidizable impurities such as aluminum, calcium and magnesium can be reduced by blowing oxygen and/or air into molten metallic silicon, converting the impurities to oxides, and removing them as the slug. On the other hand, those impurities which are not readily oxidizable as compared with silicon, such as iron and titanium are not removed for the most part by this step. The remedy is to use a silica stone with low contents of such impurities or to effect chemical purification as by leaching using chlorine, hydrofluoric acid, hydrochloric acid, sulfuric acid or nitric acid. Also, the step of pouring the melt into water for water cooling and granulating, referred to as “water granulation,” is recently employed to facilitate subsequent steps of crushing and comminution after cooling, but unfavorable because it results in an increased amount of oxygen.

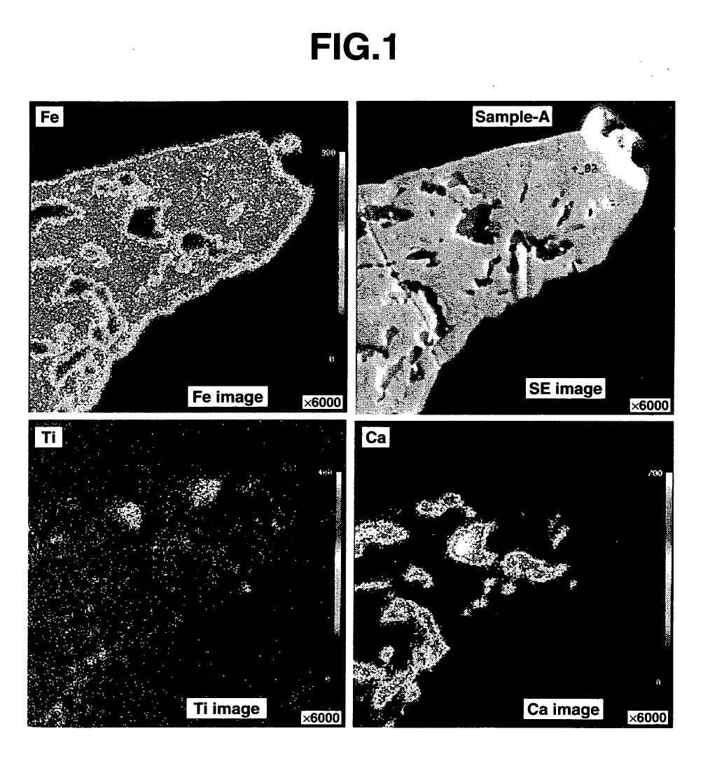

More particularly, metallic silicon prepared by chemical reduction of silica stone in an arc furnace generally contains aluminum, iron, calcium, titanium, boron, phosphorus and other impurities originating from the starting silica stone, reducing agent and carbon electrodes, and oxygen and other impurities originating, in the process aspect, from purifying and cooling steps as well. Silicon is a highly crystalline material and characterized by the strong likelihood of forming alloys with metals. Of the foregoing impurities, such metals as aluminum, iron, calcium and titanium are present segregated at grain boundaries as the alloys with silicon, i.e., silicides (see FIG. 1).

When silicon is used as the negative electrode active material in lithium ion secondary cells, silicon occludes lithium as a silicide such as Li_{4.4}Si upon charging and releases lithium upon discharging, which is repeated to provide secondary cell operation. In the process, the silicon itself undergoes significant changes including volume changes, by which the impurity layers are delaminated and remain in the system as foreign matter and sometimes deposit on the separator to inhibit ion migration. These impurities deposit on the electrode surface as well to obstruct the current collecting ability, eventually leading to degradation of cycle performance. Some oxygen is present dissolved in the silicon and some oxygen is present at grain boundaries, and both gradually react with lithium, leading to a decline of capacity with repeated cycles.

For the purification of metallic silicon, readily oxidizable impurities such as aluminum, calcium and magnesium are removed through oxidation by blowing oxygen and/or air in the molten state immediately after taking out in a ladle in the refinement process. In addition, iron, titanium and analogous impurities capable of forming alloys (or intermetallic compounds) are effectively removed by a modification during solidification such as directional solidification. Alternatively, impurity removal is achieved by leaching metallic silicon as crushed with an oxidizing agent such as chlorine, or by pickling metallic silicon as crushed and/or milled with acids such as hydrofluoric acid, hydrochloric acid and sulfuric acid. The purifying technique is not particularly limited. Metallurgical techniques are preferred from the standpoint of preventing any increase of oxygen content.

On the other hand, oxygen is temporarily increased somewhat by blowing oxygen and/or air into the melt immediately after the refinement. Since oxygen immediately forms a slug, the oxygen increase can be avoided by removing the slug to a full extent. Some particular cooling processes, for example, quenching by pouring the melt into water, known as water granulation, are unfavorable because the oxygen content is increased.

With respect to the pulverization of metallic silicon, an ordinary pulverizing method including crushing on a crusher and milling on a jet mill, ball mill or bead mill may be employed. When pulverization is carried out to fine particles with a size of less than 1 μm, the proportion of oxide layer increases due to increased surface areas. In such a case, it is more effective to pulverize in a non-polar medium such as hexane to prevent any contact with air, followed by drying and subsequent steps.

The metallic silicon is purified to reduce the content of impurities, preferably to such an extent that the contents of aluminum and iron present at grain boundaries are each equal to or less than 1,000 ppm, more preferably equal to or less than 500 ppm, the contents of calcium and titanium are each equal to or less than 500 ppm, more preferably equal to or less than 300 ppm, and the content of oxygen dissolved in silicon is equal to or less than 300 ppm, more preferably equal to or less than 200 ppm. The lower (approximate to 0 ppm if discussed on the order of ppm) the impurity content, the better the results are. However, extreme purification may entail a more expense. From such an economical aspect, practically acceptable cycle performance is achievable even when the contents of aluminum and iron are each equal to or more than 50 ppm, especially equal to or more than 100 ppm, the contents of calcium and titanium are each equal to or more than 10 ppm, especially equal to or more than 20 ppm, and the content of oxygen is equal to or more than 50 ppm, especially equal to or more than 100 ppm.

The metallic silicon powder used as the negative electrode material in non-aqueous electrolyte secondary cells according to the invention should preferably have an average particle size of equal to or less than 50 μm. Typically, a metallic silicon mass prepared by an industrial purification process as described above is crushed and milled into a metallic silicon powder having an average particle size of 0.1 to 50 μm, more preferably 0.1 to 30 μm, and most preferably 0.1 to 20 μm. The pulverizing (crushing and milling) method and atmosphere are not particularly limited. When metallic silicon is used as a negative electrode material, it is necessary to avoid those particles having a size greater than the thickness of the negative electrode film. Such coarse particles should be previously removed. It is noted that the average particle size is determined as a weight average diameter D₅₀ (particle diameter at 50% by weight cumulative, or median diameter) upon measurement of particle size distribution by laser light diffractometry.

The range from a minimum particle diameter to a maximum particle diameter of silicon particles is preferably from 50 nm to 50 μm, more preferably from 100 nm to 40 μm, most preferably from 0.1 μm to 20 μm, and a uniform particle diameter is preferred.

For the purpose of enhancing the adhesion between the metallic silicon particles and a binder, surfaces of the metallic silicon particles are advantageously treated with one or more organosilicon surface-treating agents selected from among silane coupling agents, (partial) hydrolytic condensates thereof, silylating agents such as organopolysilazanes, and silicone resins, as represented by formulae (1) to (3) below. It is noted that the (partial) hydrolytic condensates refers to partial hydrolytic condensates or complete hydrolytic condensates.
R(₄₋ₐ₎Si(Y)ₐ (1)
R_{b}Si(Z)_{(4-b)/2} (2)
R′_{c}(R″O)_{d}SiO_{(4-c-d)/2} (3)

R is a monovalent organic group, Y is a monovalent hydrolyzable group or hydroxyl group, Z is a divalent hydrolyzable group, a is an integer of 1 to 4, b is a positive number of 0.8 to 3, preferably 1 to 3; R′ is hydrogen or a substituted or unsubstituted monovalent hydrocarbon group of 1 to 10 carbon atoms, R″ is hydrogen or a substituted or unsubstituted monovalent hydrocarbon group of 1 to 6 carbon atoms, c and d are 0 or positive numbers satisfying 0≦c≦2.5, 0.01≦d≦3, and 0.5≦c+d≦3.

Examples of R include unsubstituted monovalent hydrocarbon groups, such as alkyl, cycloalkyl, alkenyl, aryl and aralkyl groups of 1 to 12 carbon atoms, preferably 1 to 10 carbon atoms; substituted monovalent hydrocarbon groups in which some or all of the hydrogen atoms on the foregoing groups are replaced by functional groups such as halogen atoms (e.g., chloro, fluoro, bromo), cyano, oxyalkylene (e.g., oxyethylene), polyoxyalkylene (e.g., polyoxyethylene), (meth)acrylic, (meth)acryloxy, acryloyl, methacryloyl, mercapto, amino, amide, ureido, and epoxy groups; and the foregoing substituted or unsubstituted monovalent hydrocarbon groups which are separated by an oxygen atom, NH, NCH₃, NC₆H₅, C₆H₅NH—, H₂NCH₂CH₂NH— or similar group.

Illustrative examples of R include alkyl groups such as CH₃—, CH₃CH₂—, CH₃CH₂CH₂—, alkenyl groups such as CH₂═CH—, CH₂═CHCH₂—, CH₂═C(CH₃)—, aryl groups such as C₆H₅—, ClCH₂—, ClCH₂CH₂CH₂—, CF₃CH₂CH₂—, (CN)CH₂CH₂—, CH₃—(CH₂CH₂O)₃—CH₂CH₂CH₂—, CH₂(O)CHCH₂OCH₂CH₂CH₂— wherein CH₂(O)CHCH₂ stands for glycidyl, CH₂═CHCOOCH₂—, 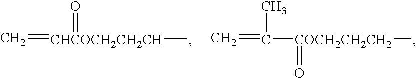
HSCH₂CH₂CH₂—, NH₂CH₂CH₂CH₂—, NH₂CH₂CH₂NHCH₂CH₂CH₂—, NH₂CONHCH₂CH₂CH₂—, etc. Preferred examples of R include γ-glycidyloxypropyl, β-(3,4-epoxycyclohexyl)ethyl, γ-aminopropyl, γ-cyanopropyl, γ-acryloxypropyl, γ-methacryloxypropyl, and γ-ureidopropyl.

The monovalent hydrolyzable groups represented by Y include alkoxy groups such as —OCH₃, —OCH₂CH₃, amino groups such as —NH₂, —NH—, —N═, —N(CH₃)₂, —Cl, oxyimino groups such as —ON═C(CH₃)CH₂CH₃, aminooxy groups such as —ON(CH₃)₂, carboxyl groups such as —OCOCH₃, alkenyloxy groups such as —OC(CH₃)═CH₂, —CH(CH₃)—COOCH₃, —C(CH₃)₂—COOCH₃, etc. The groups of Y may be the same or different. Preferred examples of Y include alkoxy groups such as methoxy and ethoxy, and alkenyloxy groups such as isopropenyloxy.

The divalent hydrolyzable groups represented by Z include imide residues (—NH—), substituted or unsubstituted acetamide residues, urea residues, carbamate residues, and sulfamate residues.

The subscript “a” is an integer of 1 to 4, preferably 3 or 4, b is a positive number of 0.8 to 3, preferably 1 to 3.

Illustrative examples of the silane coupling agents are alkoxysilanes including tetraalkoxysilanes, organotrialkoxysilanes and diorganodialkoxysilanes such as methyltrimethoxysilane, tetraethoxysilane, vinyltrimethoxysilane, methylvinyldimethoxysilane, γ-aminopropyltriethoxysilane, γ-mercaptopropyltrimethoxysilane, γ-cyanopropyltrimethoxysilane, N-β-(aminoethyl)-γ-aminopropyltrimethoxysilane, γ-methacryloxypropyltrimethoxysilane, γ-glycidyloxypropyltrimethoxysilane, β-(3,4-epoxycyclohexyl)ethyltrimethoxysilane, and γ-ureidopropyltrimethoxysilane. The silane coupling agents may be used alone or in admixture of two or more. Hydrolytic condensates (organopolysiloxanes) and/or partial hydrolytic condensates (alkoxy-containing organopolysiloxanes) of these silanes are also acceptable.

Illustrative examples of the silylating agents having formula (2) include organo(poly)silazanes such as hexamethyldisilazane, divinyltetramethyldisilazane, tetravinyldimethyldisilazane, and octamethyltrisilazane, N,O-bis(trimethylsilyl)acetamide, N,O-bis(trimethylsilyl)carbamate, N,O-bis(trimethylsilyl)sulfamate, N,O-bis(trimethylsilyl)trifluoroacetamide, and N,N′-bis(trimethylsilyl)urea. Of these, divinyltetramethyldisilazane is most preferred.

Illustrative examples of the silicone resins having formula (3) include organosiloxane oligomers of 2 to about 50 silicon atoms, preferably 2 to about 30 silicon atoms, having at least one, preferably at least two residual alkoxy groups in the molecule, which are obtained through partial hydrolytic condensation of alkoxysilanes having 2 to 4 alkoxy groups in the molecule, including tetraalkoxysilanes, organotrialkoxysilanes and diorganodialkoxysilanes such as tetraethoxysilane, vinyltrimethoxysilane, and methylvinyldimethoxysilane, as exemplified above as the silane coupling agent.

The surface treating agent is typically used in an amount of 0.1 to 50% by weight, preferably 0.5 to 30% by weight, more preferably 1 to 5% by weight based on the weight of silicon powder.

In a preferred embodiment of the invention, surfaces of silicon particles are coated with carbon through thermal CVD using an organic matter gas, for thereby rendering the particles conductive. Specifically, the metallic silicon powder prepared above is heat treated in an atmosphere containing at least organic matter gas and/or vapor and at a temperature of 800 to 1,400° C., preferably 900 to 1,300° C., more preferably 1,000 to 1,200° C. for effecting chemical vapor deposition on surfaces whereby it exhibits better negative electrode material properties.

The organic material used to generate the organic gas is selected from those materials capable of producing carbon (graphite) through pyrolysis at the heat treatment temperature, especially in a non-oxidizing atmosphere. Exemplary are hydrocarbons such as methane, ethane, ethylene, acetylene, propane, butane, butene, pentane, isobutane, and hexane alone or in admixture of any, and monocyclic to tricyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene alone or in admixture of any. Also, gas light oil, creosote oil and anthracene oil obtained from the tar distillation step are useful as well as naphtha cracked tar oil, alone or in admixture.

For the thermal CVD (thermal chemical vapor deposition), any desired reactor having a heating mechanism may be used in a non-oxidizing atmosphere. Depending on a particular purpose, a reactor capable of either continuous or batchwise treatment may be selected from, for example, a fluidized bed reactor, rotary furnace, vertical moving bed reactor, tunnel furnace, batch furnace and rotary kiln. The treating gas used herein may be the aforementioned organic gas alone or in admixture with a non-oxidizing gas such as Ar, He, H₂ or N₂.

The amount of carbon coated or deposited on the metallic silicon particles is preferably 5 to 70% by weight, more preferably 5 to 50% by weight, most preferably 10 to 40% by weight based on the carbon-coated silicon particle powder (i.e., powder of metallic silicon particles whose surface is coated with a conductive carbon coating by CVD). With a carbon coating amount of less than 5% by weight, the silicon powder is improved in conductivity, but may provide unsatisfactory cycle performance when assembled in a lithium ion secondary cell. A carbon coating amount of more than 70% by weight indicates a too high carbon proportion which may reduce the negative electrode capacity.

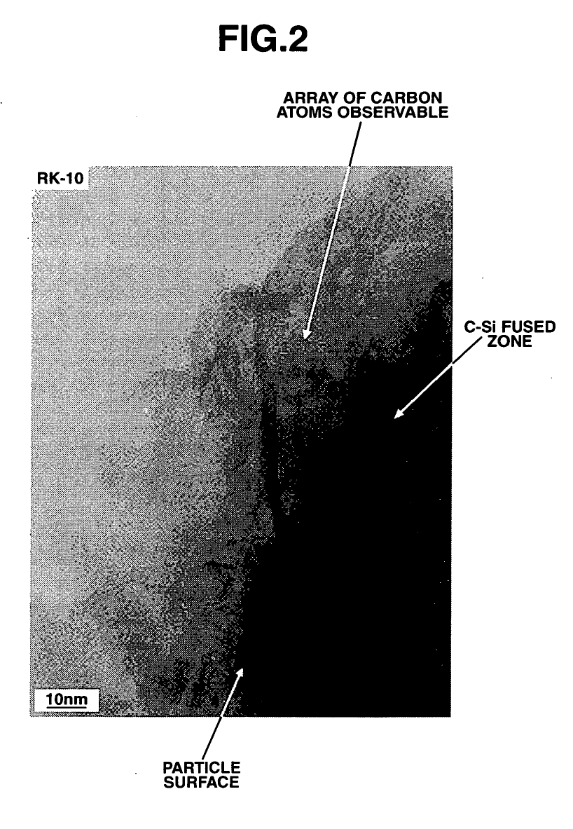

The heat treatment temperature is preferably such as to induce fusion between a carbon layer and a silicon core and specifically in the range of 800 to 1,400° C., preferably 900 to 1,300° C., and more preferably 1,000 to 1,200° C. Surface fusion by CVD means the state that carbon and silicon are co-present between a carbon layer comprising a laminar array of carbon atoms and the silicon core and fusion occurs at the interface, the state being observable under a transmission electron microscope (see FIG. 2).

If necessary, the metallic silicon powder as carbon coated is pulverized to a desired particle size. The carbon-coated metallic silicon powder is pulverized to an average particle size of 0.1 to 50 μm, more preferably 0.1 to 30 μm, and most preferably 0.1 to 20 μm as well. The pulverizing method and atmosphere are not particularly limited. For use as a negative electrode material, it is necessary to avoid those particles having a size greater than the thickness of the negative electrode film. Such coarse particles should be previously removed.

Whether the metallic silicon powder of the invention is coated with carbon or not, it may be used as a negative electrode material, specifically a negative electrode active material to construct a non-aqueous electrolyte secondary cell, especially a lithium ion secondary cell, having a high capacity and improved cycle performance.

The lithium ion secondary cell thus constructed is characterized by the use of the metallic silicon powder as the negative electrode active material while the materials of the positive electrode, electrolyte, and separator and the cell design are not critical. For example, the positive electrode active material used herein may be selected from transition metal oxides and chalcogen compounds such as LiCoO₂, LiNiO₂, LiMn₂O₄, V₂O₅, MnO₂, TiS₂ and MoS₂. The electrolytes used herein may be lithium salts such as lithium perchlorate in non-aqueous solution form. Examples of the non-aqueous solvent include propylene carbonate, ethylene carbonate, dimethoxyethane, γ-butyrolactone and 2-methyltetrahydrofuran, alone or in admixture. Use may also be made of other various non-aqueous electrolytes and solid electrolytes.

When a negative electrode is prepared using the inventive metallic silicon or carbon-coated metallic silicon powder, a conductive agent such as graphite may be added to the powder. The type of conductive agent used herein is not critical as long as it is an electronically conductive material which does not undergo decomposition or alteration in the cell. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

The amount of conductive agent added is preferably 20 to 70% by weight, more preferably 30 to 60% by weight, even more preferably 30 to 50% by weight of the metallic silicon powder or carbon-coated metallic silicon powder. Less than 20% by weight of the conductive agent may not fully exert the effect. More than 70% by weight of the conductive agent may have a reduced charge/discharge capacity.

### EXAMPLE

Examples are given below together with Comparative Examples for illustrating the present invention. The invention is not limited to these Examples. All percents are by weight.

### Example 1

Metallic silicon of the chemical grade (low aluminum grade by SIMCOA Operations PTY. Ltd., Australia; Al 0.04%, Fe 0.21%, Ca 0.001%, Ti 0.005%, and O<0.01%) which had been purified by blowing oxygen into the melt at the stage immediately after taking out in a ladle so that the contents of Al and Ca were reduced from 0.23% and 0.07% to the above-identified values, respectively, was crushed on a jaw crusher, and milled on a ball mill and a bead mill using hexane as the dispersing medium, into fine particles having an average particle size of about 4.0 μm. The resulting suspension was filtered and dried (solvent removal) in a nitrogen atmosphere. A coarse particle fraction was cut off using a pneumatic precision classifier (Nisshin Engineering Co., Ltd.), obtaining a powder having an average particle size of about 3.5 μm. The silicon fine powder was subjected to thermal CVD in a methane-argon stream at 1,200° C. for 5 hours, obtaining a carbon-surface-coated silicon powder having a free carbon content of 21%. The powder was fully cooled down, and comminuted on a grinder Mass Colloider with a set clearance of 20 μm, obtaining the target silicon powder having an average particle size of about 10 μm.

### Comparative Example 1

In the process of preparing metallic silicon of the chemical grade, metallic silicon (low aluminum grade by SIMCOA; Al 0.23%, Fe 0.25%, Ca 0.07%, Ti 0.01%, and O<0.01%) was not purified by blowing oxygen into the melt so as to reduce the contents of Al and Ca. As in Example 1, the metallic silicon was crushed on a jaw crusher, and milled on a ball mill and a bead mill using hexane as the dispersing medium, into fine particles having an average particle size of about 3.8 μm. The resulting suspension was filtered and dried in a nitrogen atmosphere. A coarse particle fraction was cut off using a pneumatic precision classifier (Nisshin Engineering Co., Ltd.), obtaining a powder having an average particle size of about 3.5 μm. The silicon fine powder was subjected to thermal CVD in a methane-argon stream at 1,200° C. for 5 hours, obtaining a carbon-surface-coated silicon powder having a free carbon content of 22%. The powder was fully cooled down, and comminuted on a grinder Mass Colloider with a set clearance of 20 μm, obtaining the target silicon powder having an average particle size of about 11 μm.

The silicon powder having a narrow particle size distribution resulting from cutting off a coarse particle fraction was evaluated as the negative electrode active material for a lithium ion secondary cell.

Cell Test

The evaluation of silicon powder as the negative electrode active material for a lithium ion secondary cell was carried out by the following procedure which was common to Example 1 and Comparative Example 1. A negative electrode material mixture was obtained by adding synthetic graphite (average particle diameter D₅₀=5 μm) to the carbon-coated silicon particles so that carbon of the synthetic graphite and free carbon of the carbon-coated silicon particles summed to 40%. To the mixture, 10% of polyvinylidene fluoride was added. N-methylpyrrolidone was then added thereto to form a slurry. The slurry was coated onto a copper foil of 20 μm gage and dried at 120° C. for one hour. Using a roller press, the coated foil was shaped under pressure into an electrode sheet, of which 2 cm² discs were punched out as the negative electrode.

To evaluate the charge/discharge performance of the negative electrode, a test lithium ion secondary cell was constructed using a lithium foil as the counter electrode. The electrolyte solution used was a non-aqueous electrolyte solution of lithium phosphorus hexafluoride in a 1/1 (by volume) mixture of ethylene carbonate and 1,2-dimethoxyethane (containing 2 wt % of vinylene carbonate) in a concentration of 1 mol/liter. The separator used was a microporous polyethylene film of 30 μm thick.

The lithium ion secondary cell thus constructed was allowed to stand overnight at room temperature. Using a secondary cell charge/discharge tester (Nagano K.K.), a charge/discharge test was carried out on the cell. Charging was conducted with a constant current flow of 3 mA until the voltage of the test cell reached 0 V, and after reaching 0 V, continued with a reduced current flow so that the cell voltage was kept at 0 V, and terminated when the current flow decreased below 100 μA. Discharging was conducted with a constant current flow of 3 mA and terminated when the cell voltage rose above 2.0 V, from which a discharge capacity was determined.

The initial efficiency of this lithium ion secondary cell was determined. By repeating the above operations, the charge/discharge test on the lithium ion secondary cell was carried out 50 cycles. The test results are shown in Table 1. It is noted that the capacity is calculated based on the weight of negative electrode film.

TABLE 1

| | | | Comparative |
|---|---|---|---|
| | | Example 1 | Example 1 |
| Raw material | | purified | unpurified |
| | | silicon powder | silicon powder |
| Impurities | Al (%) | 0.04 | 0.23 |
| | Fe (%) | 0.21 | 0.25 |
| | Ca (%) | 0.001 | 0.07 |
| | Ti (%) | 0.005 | 0.01 |
| | O (%) | <0.01 | <0.01 |

| | | |
|---|---|---|
| Average particle size of metallic | 3.5 | 3.5 |
| silicon powder prior to CVD, μm | | |
| Average particle size of | 10 | 11 |
| carbon-coated metallic silicon | | |
| powder, μm | | |
| CVD free carbon, % | 21 | 22 |
| Initial charge capacity, mAh/g | 2,100 | 2,200 |
| Initial efficiency, % | 90 | 89 |
| Retention at 50th cycle, % | 83 | 79 |

### Example 2

Purified metallic silicon of the chemical grade (low aluminum grade by SIMCOA; Al 0.04%, Fe 0.21%, Ca 0.001%, Ti 0.005%, and O<0.01%) used in Example 1 was crushed on a jaw crusher, and milled on a ball mill and a bead mill using hexane as the dispersing medium, into fine particles having an average particle size of about 1 μm. The resulting suspension was filtered and dried in a nitrogen atmosphere. The product containing agglomerates of particles was disintegrated on an automated mortar, obtaining a metallic silicon powder having an average particle size of 1.3 μm.

### Example 3

In the process of preparing metallic silicon of the chemical grade, metallic silicon (low aluminum grade by SIMCOA; Al 0.23%, Fe 0.25%, Ca 0.07%, Ti 0.01%, and O<0.01%) was not purified by blowing oxygen into the melt so as to reduce the contents of Al and Ca. As in Example 1, the metallic silicon was crushed on a jaw crusher, and milled on a ball mill into particles having an average particle size of 85 μm. Then 200 ml of 0.5% hydrofluoric acid was added to 100 g of the silicon powder for washing away impurities, followed by thorough rinsing. After drying, the particles were milled on a bead mill using hexane as a dispersing medium, into fine particles having an average particle size of about 1.2 μm. The resulting suspension was filtered and dried in a nitrogen atmosphere. The product was similarly disintegrated on an automated mortar, obtaining a metallic silicon powder having an average particle size of 1.3 μm (Al 0.005%, Fe 0.002%, Ca<0.001%, Ti 0.003%, and O<0.01%).

### Comparative Example 2

In the process of preparing metallic silicon of the chemical grade, metallic silicon (low aluminum grade by SIMCOA; Al 0.23%, Fe 0.25%, Ca 0.07%, Ti 0.01%, and O<0.01%) was not purified by blowing oxygen into the melt so as to reduce the contents of Al and Ca. As in Example 1, the metallic silicon was crushed on a jaw crusher, and milled on a ball mill into particles having an average particle size of 85 μm. The particles were milled on a bead mill using hexane as a dispersing medium, into fine particles having an average particle size of about 1.3 μm. The resulting suspension was filtered and dried in a nitrogen atmosphere. The product was similarly disintegrated on an automated mortar, obtaining a metallic silicon powder having an average particle size of 1.5 μm.

### Comparative Example 3

In the process of preparing metallic silicon of the chemical grade, metallic silicon was purified by blowing oxygen into the melt so as to reduce the contents of Al and Ca, immediately after which a part of the metallic silicon was directly poured into water for quenching. This process, known as water granulation, yielded granules with a size of about 10 mm. An analysis of the granules showed Al 0.04%, Fe 0.21%, Ca 0.001% and Ti 0.005%, with the content of oxygen being 0.36% as analyzed in the granule state. As in Example 1, the silicon was crushed on a jaw crusher, and milled on a ball mill into particles having an average particle size of 85 μm. Then 200 ml of 0.5% hydrofluoric acid was added to 100 g of the silicon powder for washing away impurities, followed by thorough rinsing. After drying, the particles were milled on a bead mill using hexane as a dispersing medium, into fine particles having an average particle size of about 1.2 μm. The resulting suspension was filtered and dried in a nitrogen atmosphere. The product was similarly disintegrated on an automated mortar, obtaining a metallic silicon powder having an average particle size of 1.3 μm.

Cell Test

The evaluation of silicon powder as the negative electrode active material for a lithium ion secondary cell was carried out by the following procedure which was common to Examples 2, 3 and Comparative Examples 2, 3. To the active material, 15% of polyvinylidene fluoride was added and N-methylpyrrolidone was then added thereto to form a slurry. The slurry was coated onto a copper foil of 20 μm gage and dried at 120° C. for one hour. Using a roller press, the coated foil was shaped under pressure into an electrode sheet. The sheet was heat treated in argon gas at 300° C. for 2 hours, after which 2 cm² discs were punched out as the negative electrode.

To evaluate the charge/discharge performance of the negative electrode, a test lithium ion secondary cell was constructed using a lithium foil as the counter electrode. The electrolyte solution used was a non-aqueous electrolyte solution of lithium phosphorus hexafluoride in a 1/1 (by volume) mixture of ethylene carbonate and 1,2-dimethoxyethane (containing 2 wt % of vinylene carbonate) in a concentration of 1 mol/liter. The separator used was a microporous polyethylene film of 30 μm thick.

The lithium ion secondary cell thus constructed was allowed to stand overnight at room temperature. Using a secondary cell charge/discharge tester (Nagano K.K.), a charge/discharge test was carried out on the cell. Charging was conducted with a constant current flow of 3 mA until the voltage of the test cell reached 0 V, and after reaching 0 V, continued with a reduced current flow so that the cell voltage was kept at 0 V, and terminated when the current flow decreased below 100 μA. Discharging was conducted with a constant current flow of 3 mA and terminated when the cell voltage rose above 2.0 V, from which a discharge capacity was determined. It is noted that the capacity is calculated based on the weight of negative electrode film.

TABLE 2

| | | Example | | Comparative Example | |
|---|---|---|---|---|---|
| | | 2 | 3 | 2 | 3 |
| Raw material | | purified | chemically | unpurified | purified |
| | | silicon | purified | silicon | silicon |
| | | powder | silicon | powder | followed |
| | | | powder | | by water |
| | | | | | granulation |
| | | | | | and milling |
| Impurities | Al (%) | 0.04 | 0.005 | 0.23 | 0.04 |
| | Fe (%) | 0.21 | 0.002 | 0.25 | 0.21 |
| | Ca (%) | 0.001 | <0.001 | 0.007 | 0.001 |
| | Ti (%) | 0.005 | 0.003 | 0.01 | 0.005 |
| | O* (%) | <0.01 | <0.01 | <0.01 | 0.36 |
| | | | (before | | |
| | | | purification) | | |

| | | | | |
|---|---|---|---|---|
| Average particle | 1.3 | 1.3 | 1.5 | 1.3 |
| size, μm | | | | |
| Initial charging | 3,800 | 3,700 | 3,650 | 3,600 |
| capacity, mAh/g | | | | |
| Initial | 90 | 89 | 88 | 85 |
| efficiency, % | | | | |
| Retention at | 69 | 71 | 64 | 63 |
| 50th cycle, % | | | | |

*Oxygen was analyzed by crushing a mass, taking a sample of appropriate size particles from the crushed product, and analyzing the sample without further milling. The analyzed value of oxygen in Example 3 is a measurement of raw material metallic silicon prior to purification.

Japanese Patent Application No. 2004-257301 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A metallic silicon powder for non-aqueous electrolyte secondary cell negative electrode material, prepared by effecting chemical reduction on silica stone, metallurgical refinement, and metallurgical and/or chemical purification to reduce the content of impurities.

2. The metallic silicon powder of claim 1 wherein the content of impurities in the metallic silicon is reduced such that the content of aluminum present at grain boundaries is up to 1,000 ppm, the contents of calcium and titanium are each up to 500 ppm, and the content of oxygen dissolved in silicon is up to 300 ppm.

3. The metallic silicon powder of claim 1, having an average particle size of up to 50 μm.

4. The metallic silicon powder of claim 1, wherein silicon particles are surface treated with at least one surface treating agent selected from the group consisting of silane coupling agents, (partial) hydrolytic condensates thereof, silylating agents, and silicone resins.

5. A carbon-coated metallic silicon powder for non-aqueous electrolyte secondary cell negative electrode material, prepared by effecting thermal CVD on the metallic silicon powder of claim 1 for coating surfaces of metallic silicon particles with carbon.

6. A non-aqueous electrolyte secondary cell negative electrode material comprising a mixture of the metallic silicon powder of claim 1 and a conductive agent, the mixture containing 5 to 60% by weight of the conductive agent and having a total carbon content of 20 to 90% by weight.

7. A non-aqueous electrolyte secondary cell negative electrode material comprising a mixture of the metallic silicon powder of claim 1 and a conductive agent, the mixture containing 5 to 70% by weight of the conductive agent and having a total carbon content of 20 to 90% by weight.

8. The metallic silicon powder of claim 2 wherein the content of iron in the metallic silicon is up to 0.21% by weight.
